(19) United States
(12) Patent Application Publication
(10) Pub. No.: US 2004/0198421 A1
(43) Pub. Date: Oct. 7, 2004

(54) Multi-radio terminals with different intermediate frequencies

(76) Inventor: Philip David Coan, San Diego, CA (US)

Correspondence Address: Qualcomm Incorporated, Patents Department, 5775 Morehouse Drive, San Diego, CA, 92121-1714, US

(21) Appl. No.: 10/359,812

(22) Filed: Feb. 7, 2003

(51) Int. Cl. H04B 1/10; H04B 7/005; H04B 7/01

(52) U.S. Cl. 455/552.1; 455/504; 455/296

(57) ABSTRACT

Terminals with multiple radio units employing different IF frequencies for RF to IF frequency downconversion are provided. Each radio unit is operative to process a respective input signal with a respective LO signal to provide a respective IF signal having a desired IF component at an IF frequency selected for that radio unit. The input signal for each radio unit includes RF components at different RF frequencies. The desired IF component for each radio unit corresponds to a downconverted version of one of the RF components in the input signal. The IF frequencies for the radio units are selected such that the desired IF components for these radio unit do not overlap one another in frequency. The IF frequencies may be selected such that, for each radio unit, the undesired IF components fall outside of the IF passband selected for that radio unit and may thus be filtered out.

### BACKGROUND

I. Field

The present invention relates generally to communication electronics, and more specifically to terminals with multiple radio units employing different intermediate frequencies for frequency downconversion.

II. Background

In a wireless digital communication system, data is typically coded and modulated at a transmitter (e.g., a base station) to obtain modulated data. The modulated data is then converted to one or more analog signals, which are filtered, amplified, and upconverted to radio frequency (RF) to obtain a modulated signal having an RF component corresponding to the modulated data. The modulated signal is then transmitted over a wireless link. At a receiver (e.g., a terminal), the transmitted signal is received, conditioned (e.g., filtered and amplified), downconverted from RF to baseband, and digitized to obtain data samples. The data samples are then digitally demodulated and decoded in a complementary manner to recover the transmitted data.

A multi-radio terminal employs multiple radio units that can simultaneously perform signal processing for multiple modulated signals transmitted by multiple base stations. These base stations may belong to different networks and may transmit their RF components on different RF channels or carriers. Each radio unit may be assigned to recover the RF component for one base station. Each radio unit may be operated independently to process a respective input signal, which includes a version of the RF component transmitted by each of the multiple base stations. Each radio unit would then provide a respective stream of data samples, which may be digitally processed to recover the data transmitted by the assigned base station.

For each radio unit, the RF to baseband frequency downconversion is typically performed using a super-heterodyne receiver architecture. For this receiver architecture, the frequency downconversion is performed by at least two stages—typically from RF to intermediate frequency (IF) by a first stage, and then from IF to baseband by a second stage. Each stage requires a local oscillator (LO) signal to perform the downconversion from an input frequency (which is either RF or IF) to an output frequency (which is either IF or baseband).

For a multi-radio terminal, multiple LO signals may be generated for, and used by, multiple radio units for the RF to IF frequency downconversion. Ideally, each radio unit receives only the LO signal generated for it, downconverts the RF component for the assigned base station to a designated IF frequency, filters out IF components for other base stations, and provides an IF signal having only the IF component for the assigned base station. However, in practice, the LO signal generated for one radio unit inevitably leaks to other radio units. For each radio unit, the desired LO signal and the leaked LO signal(s) each act to downconvert the RF components in that radio unit's input signal to IF. Undesired IF components generated by the leaked LO signal(s) may then be superimposed on the desired IF component generated by the desired LO signal. The superimposed undesired IF components would then act as noise that degrades the signal quality of the desired IF component.

The amplitude of an undesired IF component is related to the amplitude of the leaked LO signal, which in turn is dependent on the amount of LO leakage for this LO signal. Thus, to reduce the amplitude of the undesired IF component, the amplitude of the leaked LO signal and the amount of LO leakage need to be minimized. However, it may not be possible or practical to reduce the LO leakage to the requisite level needed to achieve an acceptable amount of performance degradation due to LO leakage. This may be the case, for example, if the multiple radio units are manufactured on a single circuit card assembly (CCA), which may be desirable for cost and other considerations.

There is therefore a need in the art for techniques to mitigate performance degradation due to LO leakage for multi-radio terminals.

### SUMMARY

Terminals with multiple radio units employing different IF frequencies for RF to IF frequency downconversion are provided herein. The use of different IF frequencies for different radio units can ameliorate or avoid performance degradation (e.g., signal-to-noise ratio (SNR) degradation) due to undesired IF components, which are generated by LO leakage components mixing with RF components received from multiple base stations. The multi-radio design described herein is especially beneficial if the multiple radio units are manufactured on a single CCA where it may be more difficult to suppress LO leakage by the requisite amount.

In an embodiment, a wireless multi-radio terminal is provided that comprises at least two radio units. Each radio unit is operative to process a respective input signal with a respective LO signal to provide a respective IF signal having a desired IF component at an IF frequency selected for that radio unit. The input signal for each radio unit includes RF components at different RF frequencies. The desired IF component for each radio unit corresponds to a downconverted version of one of the RF components in the input signal. The IF frequencies for the radio units are selected such that the desired IF components for these radio units do not overlap one another in frequency.

In general, the IF frequencies may be selected such that, for each radio unit, the undesired IF components fall outside of the IF passband selected for that radio unit and may thus be filtered out. Each radio unit typically includes an IF bandpass filter used to filter the IF signal to extract the desired IF component and remove the undesired IF components. The IF bandpass filters for the radio units preferably have passbands that do not overlap in frequency.

Various aspects and embodiments of the invention are described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 shows a wireless communication system;

FIG. 2 shows a block diagram of a multi-radio terminal;

FIG. 3 graphically shows the frequency downconversion process for multiple radio units with a common IF frequency;

FIG. 4 graphically shows the frequency downconversion process for multiple radio units with different IF frequencies; and

FIG. 5 shows a block diagram of a multi-radio terminal with different IF frequencies for the multiple radio units.

### DETAILED DESCRIPTION

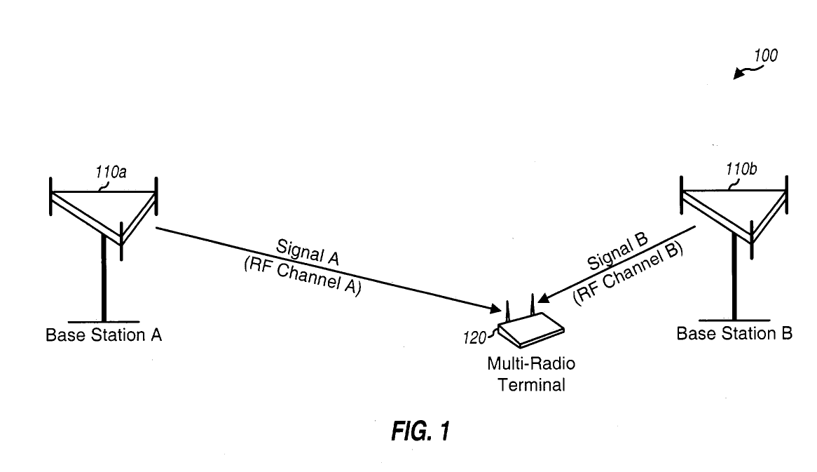

FIG. 1 shows a wireless communication system 100 with a number of base stations, each of which provides communication coverage for a respective geographic area. For simplicity, only two base stations 110a and 110b are shown in FIG. 1. A base station is a fixed station and may also be referred to as an access point, a Node B, or some other terminology. A base station and/or its coverage area are also often referred to as a “cell”, depending on the context in which the term is used. To increase capacity, the coverage area of each base station may be partitioned into multiple sectors. Each sector may be served by a corresponding base transceiver subsystem (BTS). For a sectorized cell, the base station for that cell may include all of the BTSs serving the sectors of that cell. Each BTS transmits a modulated signal on an RF channel designated for use by that BTS. For simplicity, in the following description, the term “base station” is used generically to refer to both the fixed station for a cell and the fixed station for a sector.

Various terminals are typically dispersed throughout the system. For simplicity, only one multi-radio terminal 120 is shown in FIG. 1. A terminal may also be referred to as a remote station, a mobile station, an access terminal, a user equipment (UE), a wireless communication device, or some other terminology. A terminal may communicate with one or more base stations on the forward link and one or more base stations on the reverse link at any given moment. The forward link (i.e., downlink) refers to the communication link from the base station to the terminal, and the reverse link (i.e., uplink) refers to the communication link from the terminal to the base station.

System 100 may comprise one or more networks. Each network may be a code division multiple access (CDMA) network, a time division multiple access (TDMA) network, or some other type of multiple-access network that can support communication for multiple users by sharing the available system resources. A CDMA network may implement one or more CDMA standards such as W-CDMA, IS-2000, IS-856, and IS-95. A TDMA network may implement one or more TDMA standards such as GSM. These standards are well known in the art.

In FIG. 1, base stations 110a and 110b may belong to the same network or different networks. For example, base station 110a may belong to a voice/data network that can provide voice and packet data services, and base station 110b may belong to a packet data network that can provide packet data service. Some exemplary voice/data networks include an IS-2000 network (which is also commonly referred to as a “1x” network), a W-CDMA network, and a GSM/GPRS network. An exemplary packet data network is an IS-856 network (which is also commonly referred to as a “1xEV-DO” network). Each network typically operates on a designated RF channel/carrier or a set of designated RF channels/carriers. For example, base station 110a may transmit its RF component on one RF channel centered at frequency f_{rfA} (RF channel A), and base station 110b may transmit its RF component on another RF channel centered at frequency f_{rfB} (RF channel B).

Multi-radio terminal 120 includes multiple radio units that can receive and process multiple modulated signals transmitted from multiple base stations. This capability allows the terminal to concurrently receive services from multiple networks. For example, the multi-radio terminal may concurrently maintain a voice call with one network (e.g., an IS-2000 or IS-95 network) and a packet data call with another network (e.g., an IS-856 network), even though these networks may be transmitting their RF components on different RF channels.

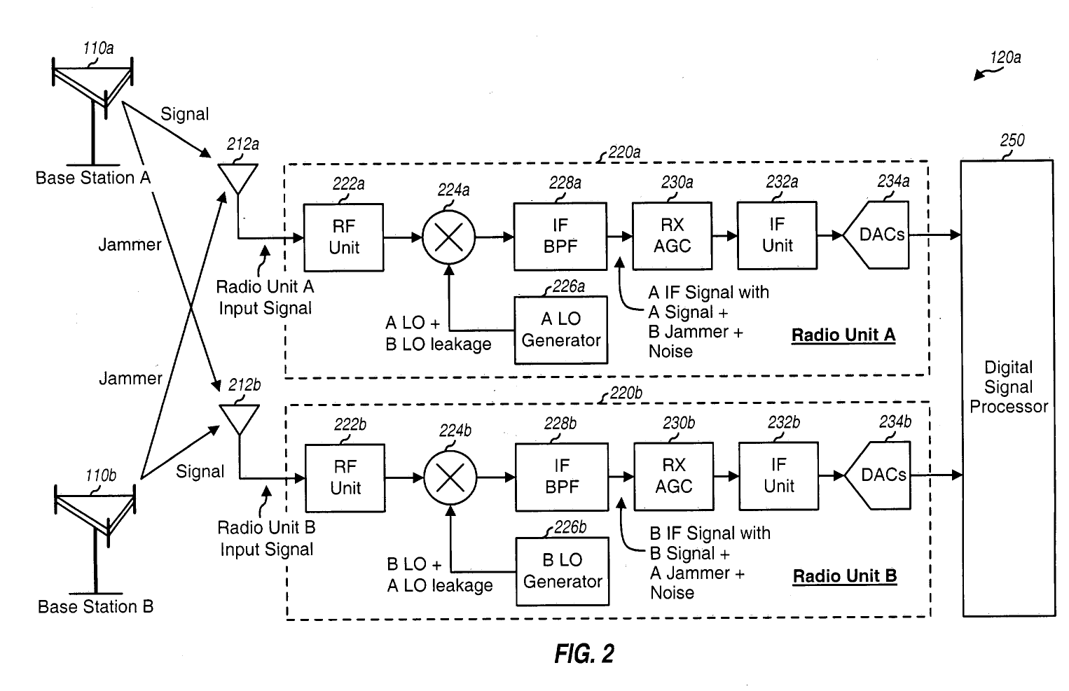

FIG. 2 shows a block diagram of a multi-radio terminal 120a, which is one embodiment of terminal 120 in FIG. 1. In this embodiment, terminal 120a is equipped with two antennas 212a and 212b. In general, a multi-radio terminal may be equipped with multiple antennas (as shown in FIGS. 1 and 2) or a single antenna. Each antenna 212 receives the modulated signals transmitted by the base stations in the system and provides a respective received signal that includes versions of the RF components from these base stations.

In the embodiment shown in FIG. 2, terminal 120a includes two radio units 220a and 220b. As used herein, a “radio unit” is a processing unit capable of performing at least RF signal processing on an input signal to provide an IF signal. A radio unit may also be designed to perform IF and/or baseband signal processing. A radio unit may thus implement just the RF portion of a super-heterodyne receiver or the entire receiver.

In the embodiment shown in FIG. 2, radio unit 220a is assigned to recover the RF component for base station A, and radio unit 220b is assigned to recover the RF component for base station B. Each radio unit 220 processes a respective input signal. The input signals for the multiple radio units may be the same or different. In particular, the multiple radio units may operate on the same received signal from one antenna, or may operate on different received signals from multiple antennas, as shown in FIG. 2. For each radio unit 220, the input signal is provided to an RF unit 222 and conditioned to provide a conditioned signal. The signal conditioning by RF unit 222 may include, for example, low noise amplification, filtering, and buffering.

A mixer 224 then receives and downconverts the conditioned signal with an LO signal to provide a downconverted signal. The frequency of the LO signal is selected such that the RF component for the assigned base station is downconverted to the designated IF frequency. An IF bandpass filter (BPF) 228 then filters the downconverted signal to remove (1) spurious signals generated by the RF to IF frequency downconversion process and (2) out-of-band noise. IF bandpass filter 228 may be implemented with a surface acoustic wave (SAW) filter or some other type of filter. IF bandpass filter 228 provides an IF signal to a receive automatic gain control (RX AGC) unit 230, which further amplifies the IF signal with a variable gain to provide an AGCed IF signal having the desired amplitude. An IF unit 232 may then perform various processing on the AGCed IF signal, such as frequency downconversion from IF to baseband, filtering, amplification, and so on. IF unit 232 provides one or more baseband or near-baseband signals that are digitized by one or more digital-to-analog converters (DACs) 234 to provide one or more streams of data samples for the radio unit. A digital signal processor 250 then processes the data sample streams from radio units 220a and 220b to recover the data transmitted by base stations A and B.

LO generators 226a and 226b respectively generate the LO signals used by radio units 220a and 220b for the RF to IF frequency downconversion. In particular, LO generator 226a provides an A LO signal, which has a fundamental frequency of f_{loA}, to mixer 224a within radio unit 220a. LO generator 226b provides a B LO signal, which has a fundamental frequency of f_{loB}, to mixer 224b within radio unit 220b. The LO signals may be of various waveform types (e.g., sinusoidal, near sinusoidal, square wave, sawtooth, and so on). The main harmonic of the A and B LO signals are at frequencies of f_{loA} and f_{loB}.

FIG. 2 shows a specific design for a multi-radio terminal having two radio units. In general, a multi-radio terminal may be designed with any number of radio units. Each radio unit may be operated to (1) process the signal transmitted in a designated RF channel, (2) process the signal received from a particular antenna, or (3) recover the signal from a particular base station. For example, multiple radio units may be operated to recover RF components transmitted by multiple base stations on different RF channels, or multiple RF components transmitted by the same base station on multiple RF channels.

FIG. 2 also shows a specific design for a radio unit. In a typical receiver, the signal conditioning and processing may be performed by one or more stages of amplifier, filter, mixer, and so on, which may be arranged differently from that shown in FIG. 2. Moreover, other circuit blocks not shown in FIG. 2 may also be used for signal conditioning and processing. The LO generators may be implemented as separate units (e.g., one LO generator for each radio unit). Alternatively, the LO generators may be implemented with a single LO generator unit capable of providing the LO signals for all radio units.

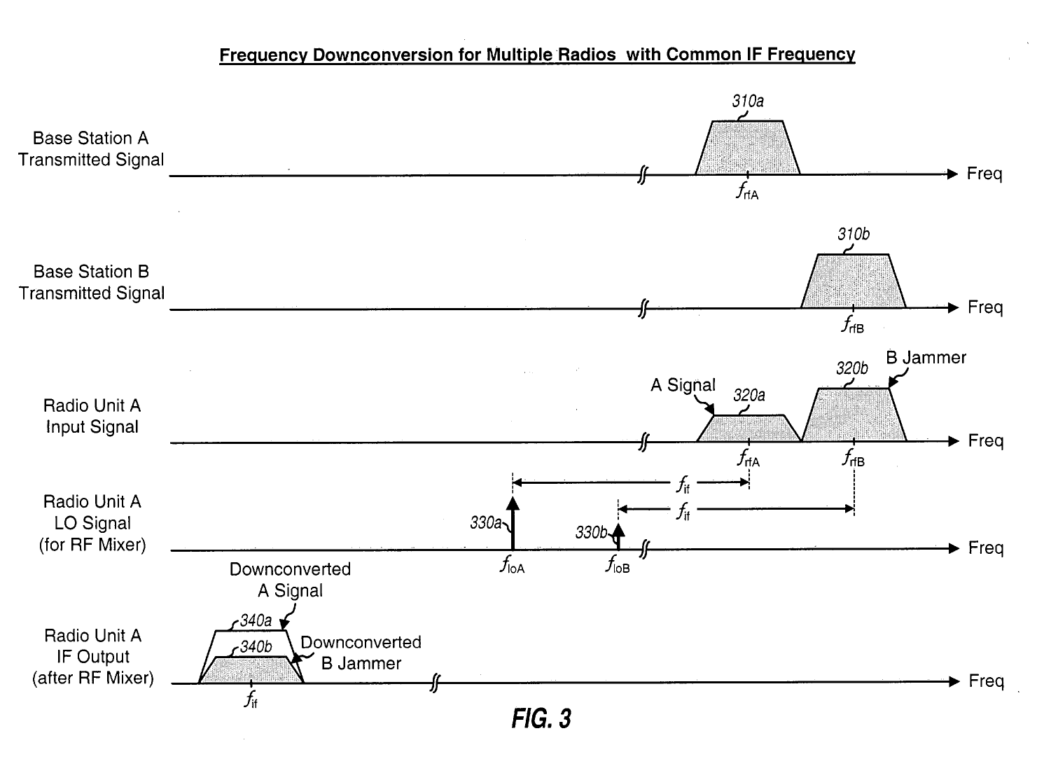

FIG. 3 graphically shows the frequency downconversion process for multiple radio units employing a common IF frequency. Base station A transmits its modulated signal having an RF component 310a centered at RF frequency f_{rfA}, and base station B transmits its modulated signal having an RF component 310b centered at RF frequency f_{rfB}. For simplicity, frequency is not drawn to scale on the horizontal axis.

The signal levels of the transmitted RF components 310a and 310b are dependent on various factors such as, for example, the limitation of the power amplifiers at the base stations, regulatory constraints, and so on. As used herein, “amplitude” and “signal level” are all related to the magnitude of a signal. Although “amplitude” may be more commonly used for some types of signal (e.g., LO signals) and “signal level” may be more commonly used for some other types of signal (e.g., modulated signals), all of these terms may be used for any given signal.

The input signal for radio unit A (i.e., radio unit 220a in FIG. 2), which is assigned to recover the RF component for base station A, includes RF components 320a and 320b for base stations A and B, respectively. The desired RF component 320a for base station A is denoted as the “A signal”, and the undesired RF component 320b for base station B is denoted as the “B jammer”. RF components 320a and 320b are versions of RF components 310a and 310b and may have been distorted by the wireless channel and other artifacts. The signal level of each RF component 320 in the input signal is dependent on (1) the transmitted signal level for the corresponding RF component and (2) the path loss between the transmitting base station and the terminal antenna. The path loss is largely dependent on the distance between the base station and terminal. Thus, there may be a large difference between the signal levels of RF components 320a and 320b in the input signal, depending on the location of the terminal relative to base stations A and B. In the worst case, RF component 320a for the assigned base station A may be received at a much lower signal level than RF component 320b for the unassigned base station B.

The mixer for radio unit A (i.e., mixer 224a in FIG. 2) is provided with a conditioned signal, which is a filtered and amplified version of the input signal and has the same RF components as in the input signal. The mixer is also provided with an LO signal used for downconverting the conditioned signal from RF to IF. This LO signal includes a desired LO component 330a (i.e., the A LO component) and an undesired LO component 330b (i.e., the B LO leakage component). The desired LO component is provided by the LO generator for radio unit A, and the undesired LO component corresponds to the leakage from the LO generator for radio unit B. The difference between the signal levels of desired LO component 330a and undesired LO component 330b is dependent on the amount of LO leakage.

The mixer for radio unit A mixes the conditioned signal with the LO signal and provides the downconverted signal having a desired IF component 340a centered at the designated IF frequency of f_{if}. IF component 340a is the result of downconverting RF component 320a with LO component 330a. If the multiple radio units of the terminal employ the same IF frequency, then the downconverted signal from the mixer also includes an undesired IF component 340b centered at the same IF frequency f_{if}. IF component 340b is the result of downconverting RF component 320b with LO component 330b.

As shown in FIG. 3, if the same IF frequency is used by the multiple radio units, then LO leakage from the other LO generator can result in an undesired IF component that falls on top of the desired IF component. The undesired IF component cannot be filtered out and would act as noise. This noise limits the SNR that may be achieved for the desired IF component for the base station assigned to the radio unit.

The signal level of each IF component is dependent on the signal level of the associated RF component and the amplitude of the associated LO component. The signal level of the undesired IF component is approximately linearly related to the amplitude of the B LO leakage component because the mixer is already biased by the A LO component. If the A signal and the B jammer are approximately equal in amplitude, then the undesired IF component will be attenuated relative to the desired IF component by the amount of LO leakage and may be negligible. However, if the B jammer is much larger than the A signal, then the undesired IF component may be large relative to the desired IF component and may significantly degrade the SNR of the desired IF component.

In an aspect, the degradation in SNR due to undesired IF components can be ameliorated or avoided by the use of different IF frequencies for different radio units. The IF frequencies may be selected such that undesired IF components resulting from the mixing of LO leakage components with RF components fall outside of the selected IF band and may be filtered out. The use of different IF frequencies to ameliorate SNR degradation is described below.

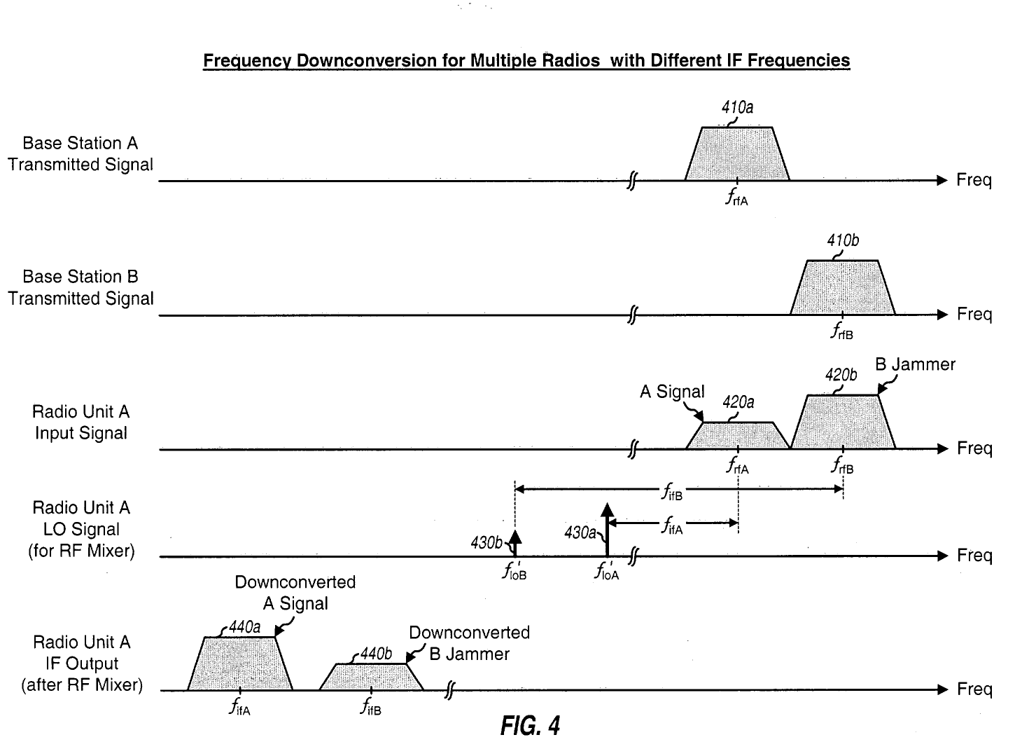

FIG. 4 graphically shows the frequency downconversion process for multiple radio units with different IF frequencies. The mixer for radio unit A is provided with a conditioned signal, which has RF components 420a and 420b for base stations A and B, respectively. The mixer is also provided with an LO signal used for downconverting the conditioned signal from RF to IF. This LO signal includes desired LO component 430a and undesired LO component 430b resulting from LO leakage.

The mixer for radio unit A mixes the conditioned signal with the LO signal and provides a downconverted signal having a desired IF component 440a centered at an IF frequency of f_{ifA}. IF component 440a is the result of downconverting RF component 420a with LO component 430a. The downconverted signal also includes an undesired IF component 440b centered at an IF frequency of f_{ifB}. IF component 440b is the result of downconverting RF component 420b with LO component 430b. Because different IF frequencies are used for different radio units, the desired and undesired IF components are located at different IF frequencies. Undesired IF component 440b may be filtered out by the IF bandpass filter placed after the mixer and would then not contribute to the noise observed by desired IF component 440a.

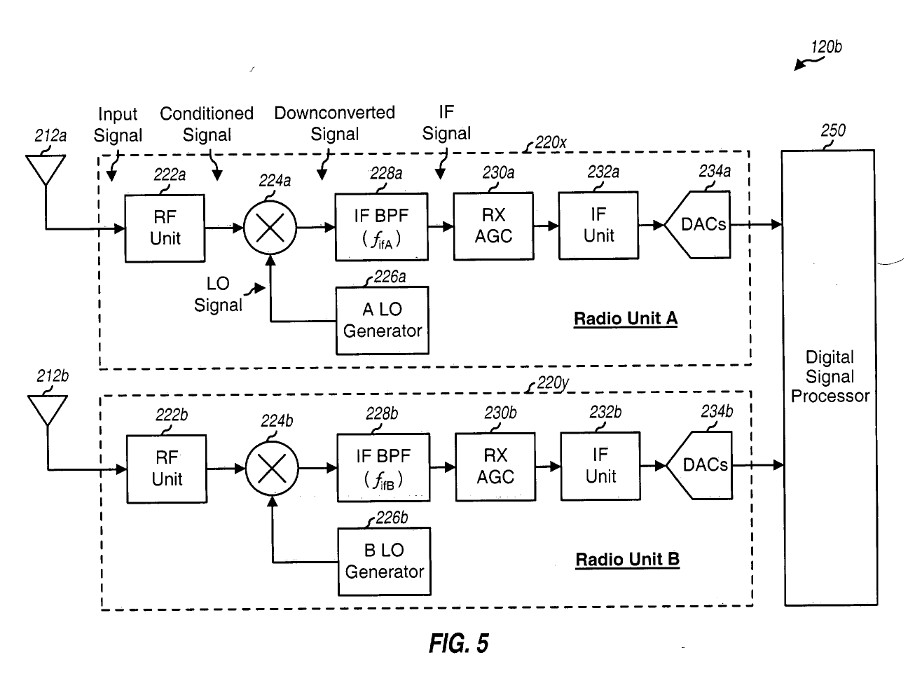

FIG. 5 shows a block diagram of a multi-radio terminal 120b, which is another embodiment of terminal 120 in FIG. 1. In this embodiment, terminal 120b includes two radio units 220x and 220y employing different IF frequencies for the RF to IF frequency downconversion. In particular, radio unit 220x is designed to use if frequency of f_{ifA} for its IF signal and radio unit 220y is designed to use IF frequency of f_{ifB} for its IF signal. LO generators 226a and 226b are designed to provide LO signals at the frequencies of f′_{loA} and f′_{loB} needed to downconvert RF components at RF frequencies of f_{rfA} and f_{rfB} to IF frequencies of f_{ifA} and f_{ifB}, respectively (e.g., f_{ifA}=f_{rfA}−f′_{loA} and f_{ifB}=f_{rfB}−f′_{loB}). IF bandpass filter 228a for radio unit 220a is centered at IF frequency f_{ifA}, and IF bandpass filter 228b for radio unit 220b is centered at IF frequency f_{ifB}. Preferably, IF bandpass filters 228a and 228b have (−3 dB) passbands that do not overlap in frequency.

The IF frequencies used by the multiple radio units may be selected based on various considerations, such as:

the spurious/jamming signals expected to be received by or generated within the terminal,

the mixing products between the spurious/jamming signals and the LO components, and

the frequencies for which commercial IF bandpass filters are readily available.

Other considerations may also be taken into account in the selection of the IF frequencies, and this is within the scope of the invention.

As shown in FIGS. 3 and 4, the input signal operated on by each radio unit may include multiple RF components. Some of these RF components may be for base stations to be recovered by the terminal. Other RF components may be for other base stations and/or generated within the terminal by other processes. All RF components of non-negligible levels may be evaluated in the selection of the IF frequencies used by the radio units.

In general, each LO component mixes with all RF components in the input signal and provides IF components corresponding to the mixing products. Moreover, each LO signal used for mixing is typically not a pure sinusoidal signal, and their harmonics also mix with the RF components and provide undesired IF components. All mixing products other than the desired IF component are often referred to as “spurs”.

For simplicity, FIGS. 3 and 4 show only two IF components generated by (1) the A LO component mixing with the A signal and (2) the B LO leakage component mixing with the B jammer. All other spurious IF components (e.g., such as the ones generated by the A LO component mixing with the B jammer, and the B LO leakage component mixing with the A signal) are not shown for simplicity. All mixing products of non-negligible levels generated by spurious signals mixing with LO components may be evaluated in the selection of the IF frequencies.

Spur charts and other analysis tools known in the art may be used in the evaluation of spurs. The IF frequencies for the radio units may be selected from among the frequency ranges where few spurs and/or spurs with small amplitude exist. The IF frequencies may also be selected based on the availability of commercial IF bandpass filters. Since SAW filters are typically used for the IF bandpass filters, and since SAW filters are manufactured in large quantity for certain IF frequencies and/or may be manufactured more cheaply for certain IF frequencies, it may be preferable to select the IF frequencies based on the availability of SAW filters.

Different IF frequencies may be used for multiple radio units within a terminal to achieve the desired performance when LO leakage cannot be kept below the requisite level. As described above, for a given radio unit (e.g., radio unit A), the LO leakage from another radio unit (e.g., B LO leakage) can mix with the jammer for that radio unit (e.g., B jammer) to provide an undesired IF component. If the undesired IF component falls within the same IF band used by radio unit A, then it will act as noise and degrade the SNR of the desired IF component for radio unit A. The undesired IF component thus acts to (1) “desense” radio unit A such that the sensitivity of radio unit A is decreased and (2) increase the sensitivity point for radio unit A. The sensitivity point denotes the input power needed to achieve a particular frame error rate (FER) for a specified data rate.

The deleterious effects of mixing products generated by LO leakage were analyzed and simulated. The analysis was for the design whereby the multiple radio units use the same IF frequency, as shown in FIG. 3.

For the simulation, two base stations A and B are placed two kilometers apart, with base station A acting as the signal source and base station B acting as an interfering source. Base station A provides coverage for a 120° sector that is approximately one third the size of an ideal cell. The ideal cell can be represented with a circle having a radius of 2 km. Base station B is located at the edge of the coverage area of base station A. Base stations A and B belong to different networks and transmit their RF components on different RF channels. The same transmit power level (e.g., 44 dBm) and antenna gain (e.g., 17 dB) are assumed for both base stations A and B.

A multi-radio terminal is randomly placed throughout the coverage area of base station A. At each location, the received SNR at the terminal is computed based on the desired signal received from base station A and the undesired signal received from base station B acting as noise. To determine the signal levels of the RF components for base stations A and B in the input signal, the path loss to each base station is first determined based on a COST-231 propagation model (which is well known in the art) and assuming a light urban/suburban environment. A 20 dB small scale fading factor is assumed for the desired signal from base station A, which effectively corresponds to an additional 20 dB of path loss. The signal level of the RF component for each base station is then determined based on the transmit power level, antenna gain, and path loss for that base station. The worst case scenario occurs when the terminal is located at the edge of base station A's coverage area—far away from base station A and close to base station B.

The SNR is computed for each terminal location. To compute the SNR, the signal level of the desired IF component for base station A is first determined based on the desired signal level. The signal level of the undesired IF component for base station B is also determined based on the undesired signal level and a particular LO leakage level (e.g., −60 dB). The SNR is then computed based on the desired IF component level, the undesired IF component level, and background noise. The background noise includes input thermal noise (which is −113 dBm for a 1.25 MHz RF channel used by IS-2000, IS-856, and IS-95 networks) and thermal noise due to circuit components (which is dependent on the input power level and may vary for different radio designs). The computed SNR is then converted to a data rate based on a table of data-rates versus minimum required SNRs. SNRs are computed for various terminal locations within the coverage area of base station A and converted to data rates. The data rates are then averaged to provide an average data rate for that particular LO leakage level.

The simulation was then repeated for different LO leakage level (e.g., −50, −40, −30, and −20 dB) and also for no LO leakage (i.e., no jamming). Table 1 lists the average data rates that may be achieved by the terminal with no LO leakage (i.e., “Unjammed Data Rate”) and with different levels of LO leakage (“Jammed Data Rates”). Table 1 is generated with −20 dB small scale fading factor for the desired signal from base station A. The rightmost column shows the reduction in data rate (in percent) caused by LO leakage. Table 1 indicates that the amount of reduction in data rate is negligible when the LO leakage is −50 dBc or lower, and can be significant when the LO leakage is −30 dBc or higher.

TABLE 1

| LO leakage | Unjammed | Jammed | Data Rate |
|---|---|---|---|
| (dBc) | Data Rate (bps) | Data Rate (bps) | Reduction (%) |
| −60 | 2,457,600 | 2,433,024 | 1.0 |
| −50 | 2,457,600 | 2,381,414 | 3.1 |
| −40 | 2,457,600 | 2,251,162 | 8.4 |
| −30 | 2,457,600 | 1,828,454 | 25.6 |
| −20 | 2,457,600 | 1,061,683 | 56.8 |

For cost and other considerations, it may be highly desirable to manufacture multiple radio units on a single circuit card assembly (CCA). The single CCA design may make it extremely difficult to achieve the LO leakage level needed to ensure minimal impact on SNR degradation and data rate reduction. The use of different IF frequencies ameliorates the SNR degradation due to LO leakage.

The multi-radio design described herein may be implemented by various means. In particular, the multiple radios may be implemented with one or more integrated circuits (ICs), discrete components, other electronic units designed to perform the functions described herein, or a combination thereof. For example, each radio unit may be implemented as a separate unit using one or more integrated circuits and other electronic circuitry. As another example, the multiple radio units may be implemented in one unit with one or more shared integrated circuits and possibly other electronic circuitry. The multiple radio units may also be manufactured on one CCA or multiple CCAs.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless terminal comprising:
a first radio unit operative to process a first input signal with a first local oscillator (LO) signal to provide a first intermediate frequency (IF) signal having a first IF component at a first IF frequency; and
a second radio unit operative to process a second input signal with a second LO signal to provide a second IF signal having a second IF component at a second IF frequency, and
wherein the first and second input signals each include a first radio frequency (RF) component at a first RF frequency and a second RF component at a second RF frequency, wherein the first and second IF components correspond to downconverted versions of the first and second RF components, respectively, and wherein the first and second IF frequencies are selected such that the first and second IF components do not overlap one another in frequency.

2. The terminal of claim 1, wherein each of the first and second radio units includes
an RF unit operative to condition the input signal to provide a conditioned signal, and
a mixer operative to downconvert the conditioned signal with the LO signal to provide a downconverted signal used to derive the IF signal.

3. The terminal of claim 2, wherein each of the first and second radio units further includes
an IF bandpass filter operative to filter the downconverted signal to provide the IF signal.

4. The terminal of claim 3, wherein the IF bandpass filter is a surface acoustic wave (SAW) filter.

5. The terminal of claim 3, wherein IF bandpass filters for the first and second radio units have passbands that do not overlap in frequency.

6. The terminal of claim 1, wherein the first and second input signals are from a single antenna.

7. The terminal of claim 1, wherein the first and second input signals are from first and second antennas, respectively.

8. The terminal of claim 1, wherein the first and second radio units are implemented on a single circuit card assembly (CCA).

9. The terminal of claim 1, wherein the first RF component is for a first base station and the second RF component is for a second base station.

10. The terminal of claim 1, wherein the first and second IF components are further processed to concurrently obtain services from two networks.

11. An apparatus in a wireless communication system, comprising:
means for processing a first input signal with a first local oscillator (LO) signal to provide a first intermediate frequency (IF) signal having a first IF component at a first IF frequency; and
means for processing a second input signal with a second LO signal to provide a second IF signal having a second IF component at a second IF frequency, and
wherein the first and second input signals each include a first radio frequency (RF) component at a first RF frequency and a second RF component at a second RF frequency, wherein the first and second IF components correspond to downconverted versions of the first and second RF components, respectively, and wherein the first and second IF frequencies are selected such that the first and second IF components do not overlap one another in frequency.

12. The apparatus of claim 11, wherein each of the means for processing includes
means for conditioning the input signal to provide a conditioned signal, and
means for downconverting the conditioned signal with the LO signal to provide a downconverted signal used to derive the IF signal.

13. The apparatus of claim 12, wherein each of the means for processing further includes
means for filtering the downconverted signal to provide the IF signal.

14. The apparatus of claim 11, wherein the means for processing the first input signal and the means for processing the second input signal are implemented on a single circuit card assembly (CCA).

15. A integrated circuit comprising:
a first radio unit operative to process a first input signal with a first local oscillator (LO) signal to provide a first intermediate frequency (IF) signal having a first IF component at a first IF frequency; and
a second radio unit operative to process a second input signal with a second LO signal to provide a second IF signal having a second IF component at a second IF frequency, and
wherein the first and second input signals each include a first radio frequency (RF) component at a first RF frequency and a second RF component at a second RF frequency, wherein the first and second IF components correspond to downconverted versions of the first and second RF components, respectively, and wherein the first and second IF frequencies are selected such that the first and second IF components do not overlap one another in frequency.

16. A method of processing signals received via a plurality of radio frequency (RF) channels, comprising:
processing a first input signal with a first local oscillator (LO) signal to provide a first intermediate frequency (IF) signal having a first IF component at a first IF frequency; and
processing a second input signal with a second LO signal to provide a second IF signal having a second IF component at a second IF frequency, and
wherein the first and second input signals each include a first RF component at a first RF frequency and a second RF component at a second RF frequency, wherein the first and second IF components correspond to downconverted versions of the first and second RF components, respectively, and wherein the first and second IF frequencies are selected such that the first and second IF components do not overlap one another in frequency.

17. The method of claim 16, wherein the processing for each of the first and second input signals includes
conditioning the input signal to provide a conditioned signal, and
downconverting the conditioned signal with the LO signal to provide a downconverted signal used to derive the IF signal.
